(19) United States
(12) Patent Application Publication
(10) Pub. No.: US 2006/0089901 A1
(43) Pub. Date: Apr. 27, 2006

(54) Uniform price auction method

(75) Inventors: Ankonia Mordekhay, Even Yehuda (IL); Ankonina Itzhak, Herzlia (IL); Biton Nir, Herzlia (IL)

Correspondence Address: Kevin D. McCarthy;Roach Brown McCarthy & Gruber, P.C., 1620 Liberty Building, 420 Main Street, Buffalo, NY, 14202, US

(73) Assignee: Ankonian Mordekhay

(21) Appl. No.: 11/257,178

(22) Filed: Oct. 24, 2005

(30) Foreign Application Priority Data
Oct. 25, 2004 (IL) 164831

(51) Int. Cl. G06Q 40/00

(52) U.S. Cl. 705/37

(57) ABSTRACT

The invention relates to an auction method for selling a plurality of articles of same type, which comprises the steps of: (a) determining the cost C of a single article to the seller; (b) dividing the range of expected bids for the product into a limited number of prices p; (c) defining time of closure T for the auction; (d) displaying the article type to the public, and receiving bids from the public, each being in one of said prices; (e) when the time T arrives, closing the auction; (f) for each of the prices p calculating the seller's profit P; (g) from all prices p, selecting a price Q in which the seller profit P is maximal, and selling the article for the same price Q to all the customers who submitted bids with a price of Q or higher.

### FIELD OF THE INVENTION

The present invention relates to the field of auctions. More particularly, the invention relates to a method for selecting the winning bids from all the bids submitted.

### BACKGROUND OF THE INVENTION

From ancient times to modern days auctions were used as means of selling and distributing merchandise, by letting market forces determine the price. Typically, the items are presented, and bids are taken from the public. The highest bids are eventually announced as the winning bids, and each winning bid holder has the luxury of purchasing the product for the price of the bid. Auctions are very common today not only for unique artifacts that are priceless, but also for standard home commodities. These commodities or products are usually introduced to the public in predetermined quantities for bidding, whereas the highest bids are selected in accordance with the predetermined quantities.

Many auctions are conducted today through the Internet where a distributor may offer merchandise ranging from small office utilities through domestic necessities to commercial products. The huge advantages of the Internet are apparent in view of its accessibility to a huge number of consumers, and in view of it being cost effective due to the fact that there is no need for an auction house. There are many methods for auctioning over the Internet today; one of the auctioning methods specifies a quantity of products that are auctioned for a limited time. When the deadline arrives no more bids are accepted and the highest bidders are chosen. A second method utilizes a short time limit in which all the users can send their bid, once again the highest bids are chosen. Nevertheless the same disadvantages of a standard auction apply to Internet auctions, for example, the user wishes to bid as low as possible in order to save money, but bidding too low might result in loss of the offered merchandise. Other disadvantages of the prior art methods are apparent from the seller side who is obliged to distribute the predetermined quantities assigned in the auction, some of the merchandise may be sold at an unprofitable price

There are some Internet systems for selling merchandise without predetermining its price. For example U.S. Pat. No. 6,466,919 introduces a Conditional Purchase Offer (CPO) management system in which sellers can join together or alone in conditional purchases set by the seller. Nevertheless, there is no disclosure of a specific condition for purchasing. In U.S. Pat. No. 6,047,266, a method for auctioning over the Internet is introduced, where a limited quantity of merchandise is presented for bidding.

In the prior art Auction methods, when more than one winning bids are selected, the selected bids are generally gradual. For example, if six TV sets are offered in the auction, and the six highest bids which are selected are: (A) 185$; (B) 190$; (C) 190$; (D) 200$; (E) 202$; and (F) 210$, it is apparent that not all the selected six customers pay the same price. Although generally the results of the auction remain confidential, in large auctions, where many (sometimes hundreds or even more) winning bids are selected, there is a reasonable chance that one winning customer (for example customer F above) meets another winning customer (for example customer A above) and discuss about the auction. Upon disclosing one to the other their winning bids, customer F may become disappointed, as customer A has obtained the same product for a price of 25$ less in the same auction. Furthermore, even when the results of the auction remain totally confidential, a winner can never know whether he could offer a lower price for the product and still could have won. An object of the present invention is to eliminate said two drawbacks for the customers. Moreover, the present invention provides an auction method in which some of the winner customers receive their product in a price even less than the bids they submitted.

Another object of the present invention is to provide an auction method in which the selected bids almost maximize the seller profit, but still provide a significant encouragement for the customers to participate in the auction.

### SUMMARY OF THE INVENTION

The present invention relates to an auction method for selling a plurality of articles of same type, which comprises the steps of: (a) determining the cost C of a single article to the seller; (b) dividing the range of expected bids for the product into a limited number of prices p; (c) defining time of closure T for the auction; (d) displaying the article type to the public, and receiving bids from the public, each being in one of said prices; (e) when the time T arrives, closing the auction; (f) for each of the prices p calculating the seller's profit P; (g) from all prices p, selecting a price Q in which the seller profit P is maximal, and selling the article for the same price Q to all the customers who submitted bids with a price of Q or higher.

In a first embodiment, the selected price Q is a global maximum seller profit price in which P=(p−C)*N is maximum, wherein P is the seller profit, C is the article cost to the seller, and N is the number of customers who offered the price of p or above.

In a second embodiment, the price Q is a local maximum seller profit price in which P=(p−C)*n is maximum, wherein P is the seller profit, C is the article cost to the seller, and n is the number of customers who offered the price of p.

Preferably, the cost C summarizes all the product costs, including shipping and handling.

Preferably, each of the limited number of prices p is a predefined range of prices between an upper price and a lower price wherein bids can be accepted at any price within that range, and wherein the profit P is adjusted accordingly for all the bids submitted in each range.

Preferably, the article type is displayed and bids are received by means of the Internet.

Preferably, the article type is displayed and bids are received by means of a cellular network.

Preferably, the article is a service.

### BRIEF DESCRIPTION OF THE DRAWINGS

FIG. 1 is a table illustrating an example for an auction according to an embodiment of the invention; and

FIG. 2 is a flow chart illustrating the auction method of the invention.

### DETAILED DESCRIPTION OF PREFERRED EMBODIMENTS

According to the present invention, one or more types of products are offered in an auction. The products are introduced to the public, for example in a physical shop, via the Internet, via magazines that are widely distributed, or in any other manner of communication which is conventional. Of course, the products may be introduced by several channels simultaneously.

The invention will be described by means of example. For the purpose of the example, reference will be made to only one product, assuming that only this product is included in the auction. As will become apparent, the auction may be expanded to include any number of products, as the determination of the winning bids is performed for each product separately.

According to the present invention the number of articles of each product type sold in the auction is not limited, or predetermined. It is assumed that the seller can supply any number of articles that are eventually decided as winning bids. Furthermore, it is assumed that the seller can determine his costs for buying each article, as this value is important in the determination of the winning bids.

For example, let's assume that a VCR is offered for sell in an auction. The VCR is presented to the public in any conventional manner, for example in one of the manners listed above. A time limit is also set for the closure of the auction, and this time limit is also presented to the public. A minimum price, which may be identical to the seller cost of one article of VCR may also be introduced. Then, offers (bids) for the product are received at the seller side by any conventional manner.

### EXAMPLE 1

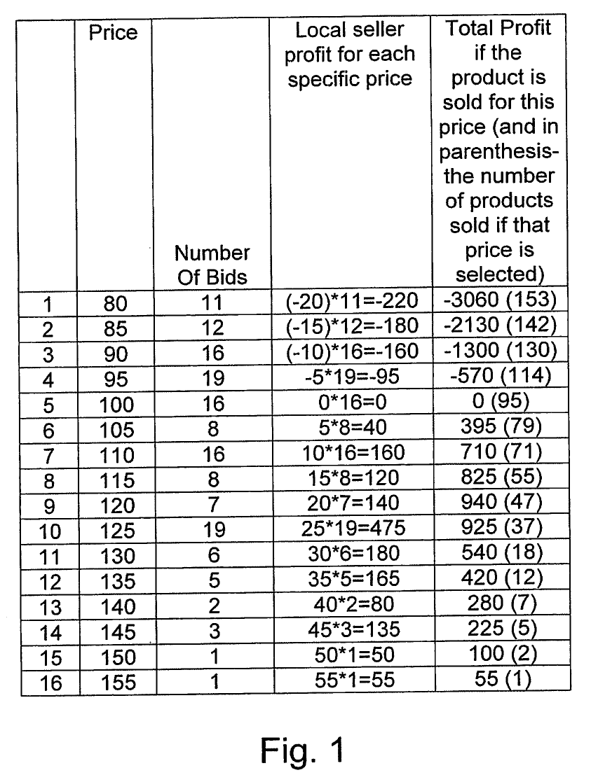

FIG. 1 shows an exemplary response of the public to an auction, offering a VCR for sell. This example assumes that the total cost of the one article of VCR to the seller is 100$. According to the present invention the range of the relevant prices for the product is divided into several fixed prices. In the Example of FIG.1, it is assumed that for the VCR whose total cost for the seller is $100, the range of between $80-$155 is divided into 16 prices, differing by steps of $5. It should be noted that the steps may not be identical throughout all the range. Then, bids are received from the public.

FIG. 1 shows that for the price of $100, 16 bids are received, for the price of $125, 19 bids, are received, and for the price of $145, 3 bids are received. As shown in the column entitled “Local seller profit for each specific price”, a separate calculation is made by the seller for determining his profit in each price. In this manner, it can be seen that in the price of $105, where 8 bids are received, the seller's profit is $40. In the price of $125, the seller's profit is $475, and for the price of $135, the seller's profit is $165. According to Example 1, the price for which the article (the VCR) is sold in the auction is the local price in which the seller's profit is maximum. In this example, this local price is determined to be $125, in which the total seller's profit is $475. According to the present invention all the 19 customers who submitted the bids of $125 will receive the VCR for the price of $125. Furthermore, all those who submitted bids higher than the selected price of $125, will receive the VCR for the same local price of $125, although they submitted bids higher than $125. In this example, all the 18 customers who submitted bids higher than $125 will receive the VCR for a price of $125. It has been shown that those which offered $125, receive the product for the price they offered. The 18 customers who offered more than $125, receive the VCR for a price less than the price they offered. In this manner, all those which receive the VCR will receive it for a same, single price (i.e, for the local price in which the profit of the seller is maximum). In this manner, the seller can never lose money. Moreover, this may encourage customers, as there are some that receive the product for a price even less than the price they offered. Finally, there are no customers who should feel bad as others could obtain the product for a lower price, as all those who receive the product, receive it for the same price. All the others who offered a price less than $125, do not receive a product following the auction.

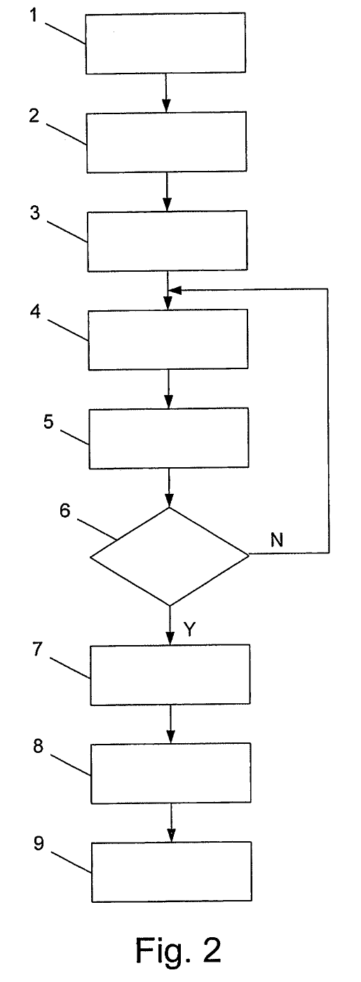

FIG. 2 is a flow chart illustrating the auction method according to an embodiment of the present invention. In step 1, the seller determines the cost C of one article for him. This may also include all the shipping and handling costs. In step 2, the range R of the product prices in which bids are expected, is divided to a limited number N of fixed prices. In step 3 a closure time T is defined. In step 4, the auction begins by displaying the product to the customers in any of conventional manners. The products may be displayed to the customers, for example via the Internet, in conventional stores, by means of promotional material, or any similar manner or combination thereof. In step 5, bids from the public are received, also by any conventional communication means. In step 6, the time of closure of the auction T is checked. If this time arrives, in step 7 the auction is closed, and no more bids are accepted. In step 8, the bids are processed separately for each price in order to determine the one price M in which the profit to the seller is locally maximized. As said, the calculation involves consideration of the cost C of each article to the seller, and number of bids offered in each price. Once this price M is determined, all customers who submitted bids for the price M, and all those who submitted bids for prices above M will receive a notification that they are eligible to receive an article for the price M. In step 9, the payment arrangements are made, and the articles are sent to the customers.

It should be noted that some arrangements and auction rules may be defined in order to consider exceptions. For example, such an exception may occur when more than one local prices M are determined which give a same maximal price to the seller. The rule may determine how this conflict is solved. For example, it may be decided that in such a case the lowest M is selected, and the product is sold to all those who submitted bids for the said lowest price M, or higher.

It should also be noted that according to the present invention the prices do not have to be discrete. In some cases, ranges of prices may be defined instead. In that case, the values within the column “Local seller profit for each specific price” may be calculated in a common manner a little bit different in order to account for the differences in prices within each range. The rest of the embodiment remains the same.

### EXAMPLE 2

According to still another embodiment, the price X which is selected is the price which not only locally maximizes his profit ($125 in example 1), but it is the price which globally maximizes the seller's profit. It can be seen in the rightmost column of FIG. 1 that the price which globally maximizes the seller's profit is $120, in which the global profit is $940 (this is in contrast to the local maximum profit which is obtained in $125, as discussed in Example 1). Therefore, in this example, the price which is selected is $120, and the product is sold to all the customers who offered $120 or more for the same price of $120.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. Auction method for selling a plurality of articles of same type, which comprises the steps of:
a. Determining the cost C of a single article to the seller;
b. Dividing the range of expected bids for the product into a limited number of prices p;
c. Defining time of closure T for the auction;
d. Displaying the article type to the public, and receiving bids from the public, each being in one of said prices;
e. When the time T arrives, closing the auction;
f. For each of the prices p calculating the seller's profit P;
g. Among all prices p, selecting a price Q in which the seller profit P is maximal, and selling the article for the same price Q to all the customers who submitted bids with a price of Q or higher.

2. Method according to claim 1, wherein the selected price Q is a global maximum seller profit price in which P=(p−C)*N is maximum, wherein P is the seller profit, C is the article cost to the seller, and N is the number of customers who offered the price of p or above.

3. Method according to claim 1, wherein the price Q is a local maximum seller profit price in which P=(p−C)*n is maximum, wherein P is the seller profit, C is the article cost to the seller, and n is the number of customers who offered the price of p.

4. Method according to claim 1, wherein the cost C summarizes all the product costs, including shipping and handling.

5. Method according to claim 1, wherein each of the limited number of prices p is a predefined range of prices between an upper price and a lower price wherein bids can be accepted at any price within that range, and wherein the profit P is adjusted accordingly for all the bids submitted in each range.

6. Method according to claim 1 wherein the article type is displayed and bids are received by means of the Internet.

7. Method according to claim 1 wherein the article type is displayed and bids are received by means of a cellular network.

8. Method according to claim 1 in which the article is a service.
